(19) United States
(12) Patent Application Publication
(10) Pub. No.: US 2020/0102097 A1
(43) Pub. Date: Apr. 2, 2020

(54) TEST RIG FOR INTERIOR COMPONENTS OF AIRCRAFT

(71) Applicant: BOMBARDIER INC., Dorval (CA)

(72) Inventors: Yann LANSSENS, Blainville (CA); Yohann BELANGER, Laval (CA); Gilles TURCOTTE, Mirabel (CA)

(73) Assignee: BOMBARDIER INC., Dorval, QC (CA)

(21) Appl. No.: 16/621,409

(22) PCT Filed: Jun. 14, 2018
(86) PCT No.: PCT/CA2018/050719

§ 371 Date: Dec. 11, 2019

Related U.S. Application Data
(60) Provisional application No. 62/520,633, filed on Jun. 16, 2017.

(51) Int. Cl. B64F 5/60; B64F 5/10

(52) U.S. Cl. CPC B64F 5/60; B64F 5/10

(57) ABSTRACT

A method of adjusting an interior component to be received in a fuselage of an assembled aircraft, including determining a deformed configuration of a fuselage portion of a test rig, the fuselage portion in the deformed configuration being bent along its longitudinal axis and being representative of at least part of the fuselage of the assembled aircraft, deforming the fuselage portion to the deformed configuration so that the fuselage portion maintains the deformed configuration in a rigid manner, installing the interior component within the fuselage portion in the deformed configuration, determining changes required in a nominal configuration of the interior component based on a fit of the interior component within the fuselage portion in the deformed configuration, and applying the required changes to the nominal configuration of the interior component before installing the interior component within the fuselage of the assembled aircraft. A test rig is also discussed.

### CROSS-REFERENCE TO RELATED APPLICATION(S)

This International PCT Patent Application relies for priority on U.S. Provisional Patent Application Ser. No. 62/520,633 filed on Jun. 16, 2017, the entire content of which is incorporated herein by reference.

### TECHNICAL FIELD

The application relates generally to the installation of interior components in aircraft and, more particularly, to the adjustment of such components to obtain a desired fit within the aircraft.

### BACKGROUND OF THE ART

Aircraft manufacturers can provide multiple configurations for the interior design of aircraft of a same model. The interior components defining each design must be adjusted to the aircraft so as to obtain a desired fit. For a high quality interior, gaps and mismatches between adjacent interior components and between the interior components and the aircraft structure should be minimized.

Interior components typically have a nominal configuration configured to fit within the nominal configuration of the aircraft fuselage, as determined for example by the CAD model of the fuselage. While the un-deformed, stand-alone fuselage may correspond to its nominal configuration within acceptable tolerances, in the assembled aircraft, the fuselage has a deformed configuration due to the weight of the various interior and exterior components attached to the fuselage (e.g., wings, engine(s), tail assembly). Accordingly, interior components must typically be adjusted upon installation in the assembled aircraft to correct the fit of the interior components within the deformed fuselage, for example by installing the component, measuring the gaps and/or other mismatches, removing the component to correct its configuration, then reinstalling the component, and repeating these steps until a desired fit is obtained. This trial and error type of installation may lead to significant delays in the installation procedure, particularly when a new interior configuration is installed, thus increasing the overall manufacturing time for the aircraft.

### SUMMARY

In one aspect, there is provided a method of adjusting an interior component to be received in a fuselage of an assembled aircraft, the fuselage of the assembled aircraft being bent along a longitudinal axis thereof due to a weight of aircraft components attached to the fuselage, the method comprising: determining a deformed configuration of a fuselage portion of a test rig, the fuselage portion in the deformed configuration being bent along a longitudinal axis thereof, the fuselage portion in the deformed configuration being representative of at least part of the fuselage of the assembled aircraft; deforming the fuselage portion of the test rig to the deformed configuration so that the fuselage portion maintains the deformed configuration in a rigid manner; installing the interior component within the fuselage portion of the test rig in the deformed configuration; determining changes required in a nominal configuration of the interior component based on a fit of the interior component within the fuselage portion in the deformed configuration; and applying the required changes to the nominal configuration of the interior component before installing the interior component within the fuselage of the assembled aircraft.

In a particular embodiment, the interior component is a first interior component, and the method further comprises: installing a second interior component adjacent the first interior component within the fuselage portion of the test rig in the deformed configuration; determining changes required in a nominal configuration of the second interior component based on a fit of the second interior component within the fuselage portion of the test rig in the deformed configuration and on a fit of the second interior component with the first interior component; and applying the required changes to the nominal configuration of the second interior component before installing the second interior component in the fuselage of the assembled aircraft.

In another aspect, there is provided a method of installing an interior component in a fuselage of an assembled aircraft, the fuselage being bent along a longitudinal axis thereof due to a weight of aircraft components attached to the fuselage, the method comprising: deforming a fuselage portion of the test rig to a deformed configuration so that the fuselage portion maintains the deformed configuration in a rigid manner, the fuselage portion in the deformed configuration being bent along a longitudinal axis thereof, the fuselage portion in the deformed configuration being representative of at least part of the fuselage of the assembled aircraft; installing the interior component within the fuselage portion of the test rig in the deformed configuration; determining changes required in a nominal configuration of the interior component based on a fit of the interior component within the fuselage portion of the test rig in the deformed configuration; removing the interior component from the fuselage portion of the test rig and applying the required changes to the nominal configuration of the interior component; and after the required changes are applied, installing the interior component within the fuselage of the assembled aircraft.

In a particular embodiment, the interior component is a first interior component, and the method further comprises: installing a second interior component adjacent the first interior component within the fuselage portion of the test rig in the deformed configuration; determining changes required in a nominal configuration of the second interior component based on a fit of the second interior component within the fuselage portion of the test rig in the deformed configuration and on a fit of the second interior component with the first interior component; applying the required changes to the nominal configuration of the second interior component; and after the required changes are applied to the nominal configuration of the second interior component, installing the second interior component within the fuselage of the assembled aircraft adjacent the first interior component.

In a particular embodiment of any of the above methods, the assembled aircraft is a first assembled aircraft forming part of a plurality of assembled aircraft of a same aircraft model, and the method further comprises, before deforming the fuselage portion of the test rig: measuring deformations of fuselages of the plurality of assembled aircraft; and determining the deformed configuration of the fuselage portion of the test rig based on average values of the measured deformations.

In a particular embodiment of any of the above methods, deforming the fuselage portion of the test rig includes applying a downward force on an end of the fuselage portion of the test rig through an annular bulkhead attached to the end of the fuselage portion.

In a particular embodiment of any of the above methods, the fuselage portion of the test rig is supported above a ground surface by a plurality of supports anchored in the ground surface and connected to the fuselage portion. Each of the supports has a height defined between the ground surface and the fuselage portion, and deforming the fuselage portion includes adjusting the height of at least one of the supports. An intermediate one of the supports may be connected to the fuselage portion in a manner representative of a connection between the fuselage of the assembled aircraft and wings of the assembled aircraft, the intermediate one of the supports having a fixed height. Adjusting the height of at least one of the supports may include adjusting the height of a front one of the supports and adjusting the height of a rear one of the supports, the intermediate one of the supports being located between the front and rear ones of the supports.

In a particular embodiment of any of the above methods, installing the interior component within the fuselage portion of the test rig in the deformed configuration is performed in accordance with an installation procedure, and the method further comprises: determining changes required in the installation procedure; and applying the required changes to the installation procedure before using the installation procedure to install the interior component within the fuselage of the assembled aircraft.

In a particular embodiment of any of the above methods, the aircraft components attached to the fuselage include a tail assembly and at least one engine.

In a further aspect, there is provided a test rig for adjusting interior components to be received within a fuselage of an assembled aircraft, the rig comprising: a fuselage portion having a longitudinal axis, the fuselage portion having a structure representative of that of at least part of the fuselage of the assembled aircraft; and a plurality of longitudinally spaced supports anchored in a ground surface and supporting the fuselage portion in an elevated position with respect to the ground surface, each of the supports having a height defined between the ground surface and the fuselage portion, the height of at least one of the supports being adjustable so as to bend the fuselage portion along the longitudinal axis to obtain and maintain a deformed configuration representative of deformations in the at least part of the fuselage of the assembled aircraft.

In a particular embodiment, the supports include an intermediate support located between front and rear supports. The intermediate support is connected to the fuselage portion in a manner representative of a connection between the fuselage of the assembled aircraft and wings of the assembled aircraft. The height of the intermediate support is fixed. The height of the front and rear supports is adjustable.

In a particular embodiment, the intermediate support includes a front beam extending forwardly therefrom and a rear beam extending forwardly therefrom, the front and rear beams connected to the fuselage portion in a manner representative of a connection between the fuselage of the assembled aircraft and a keel beam of the assembled aircraft.

In a particular embodiment, the front and rear supports are connected to annular stiffeners extending from an interior surface of a skin of the fuselage portion.

In a particular embodiment, the test rig further includes an annular bulkhead connected to a rear end of the fuselage portion. A rear one of the supports is connected to the annular bulkhead. A cable may extend around the bulkhead, having opposed ends attached to the rear one of the supports.

In a particular embodiment, the fuselage portion includes an assembly-grade fuselage component identical to a corresponding component of the fuselage of the assembled aircraft.

### DESCRIPTION OF THE DRAWINGS

For a better understanding of the present invention, as well as other aspects and further features thereof, reference is made to the following description which is to be used in conjunction with the accompanying drawings, where:

FIG. 1 is a schematic tridimensional view of an aircraft in accordance with a particular embodiment;

FIG. 2 is a schematic top tridimensional view of a test rig in accordance with a particular embodiment,

FIG. 3 is a schematic, front and side tridimensional view of the test rig of FIG. 2, with end platforms thereof being omitted;

FIG. 4a is a schematic tridimensional view of a front end of the test rig of FIG. 3;

FIG. 4b is a schematic tridimensional view of a front bulkhead of the test rig of FIG. 3;

FIG. 5 is a schematic tridimensional view of a rear end of the test rig of FIG. 3;

FIG. 6 is a schematic tridimensional view of a support of the test rig of FIG. 3;

FIG. 7 is a schematic illustration of the deformation of the fuselage of an aircraft such as shown in FIG. 1 and of a fuselage portion of a test rig such as shown in FIG. 3;

FIG. 8 is a schematic tridimensional view of an adjustment assembly adjustably interconnecting a base and a connection portion in one or more supports of the test rig of FIG. 3, in accordance with a particular embodiment;

FIG. 9 is a schematic tridimensional view of the adjustment assembly of FIG. 8, with part of a fixed element thereof removed for improved clarity;

FIG. 10 is a schematic cross-sectional view of the adjustment assembly of FIG. 8; and

FIG. 11 is a flow chart of a method of adjusting an interior component to be received in a fuselage of an assembled aircraft such as shown in FIG. 1, in accordance with a particular embodiment.

### DETAILED DESCRIPTION

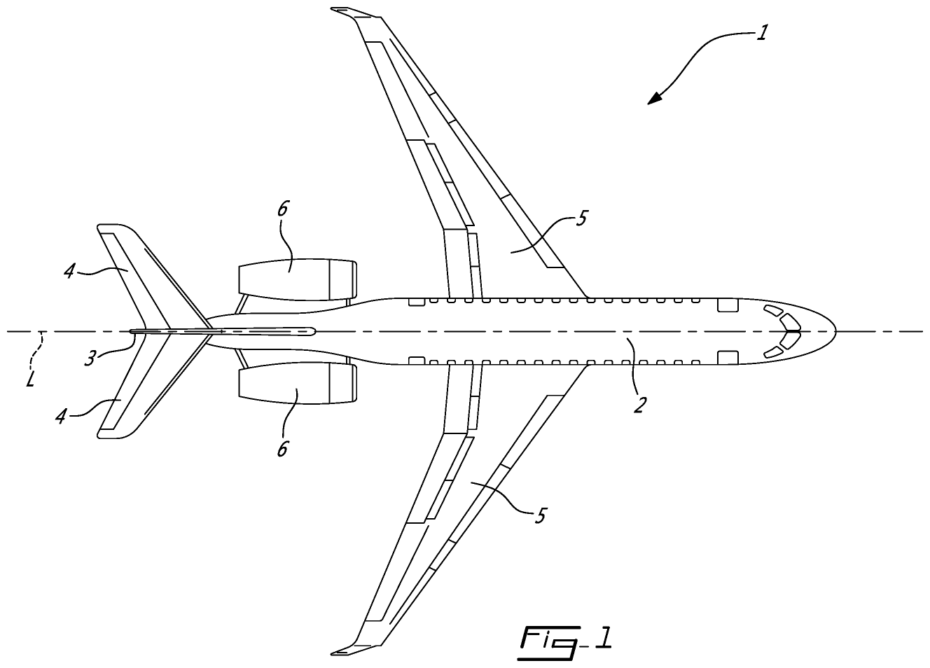

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly shown has a “T-tail” configuration, but other configurations may also be used for the aircraft 1, such as cruciform, fuselage-mounted tail, etc. Wings 5 project laterally from the fuselage. The aircraft 1 has engines 6 shown here as mounted to the fuselage 2, although the engines 6 could also be supported by the wings 5. The aircraft 1 is shown as a jet-engine aircraft, but may also be a propeller aircraft.

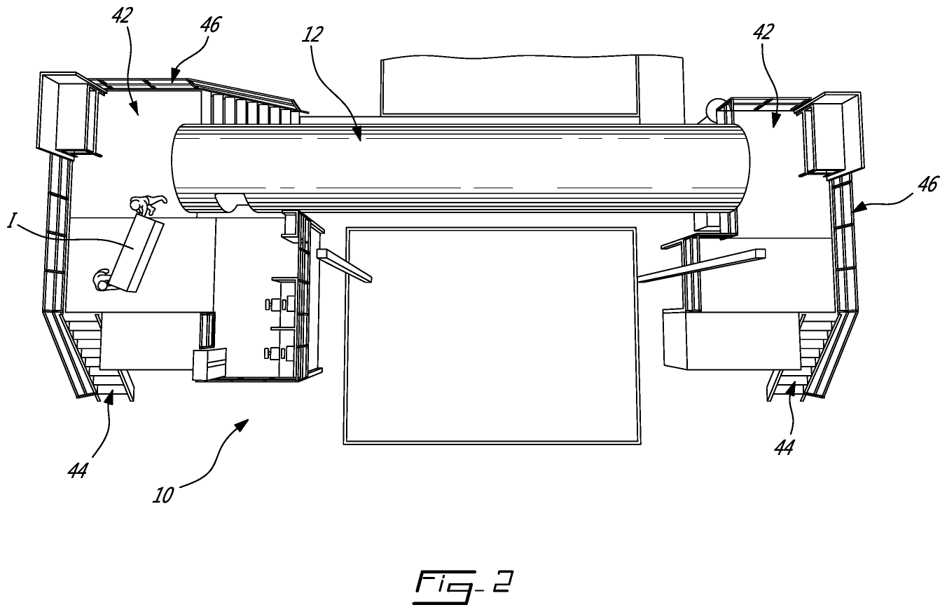

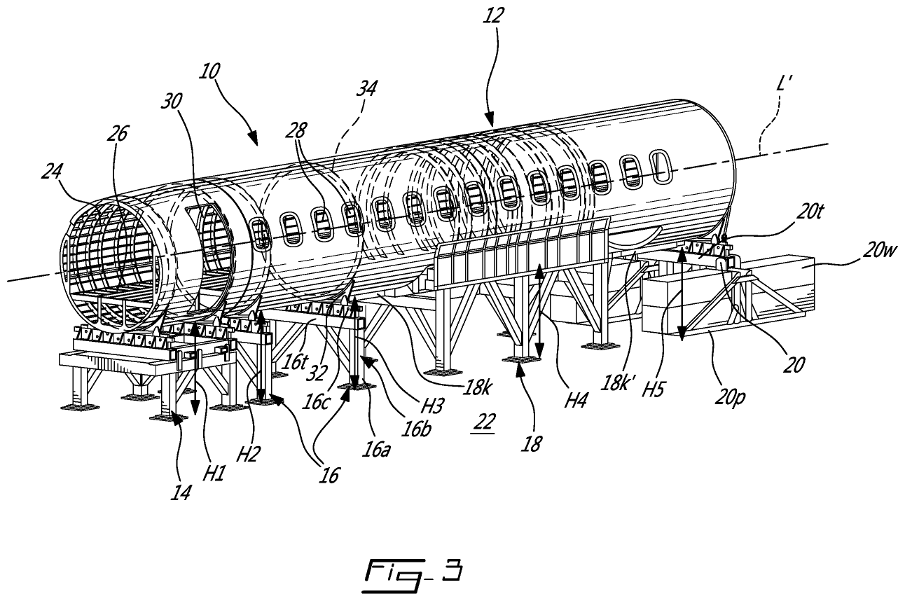

Referring to FIGS. 2-3, a test rig 10 in accordance to a particular embodiment is shown. As can be best seen in FIG. 3, the test rig 10 generally includes a fuselage portion 12 supported by longitudinally spaced supports 14, 16, 18, 20 so as to be in an elevated position with respect to a ground surface 22.

The fuselage portion 12 has a structure representative of that of at least part of the fuselage 2 of the assembled aircraft. The term “assembled aircraft” as used herein is intended to include any assembly where the fuselage 2 is connected to one or more components having sufficient weight to cause a deformation of the fuselage 2, including, but not limited to, the complete aircraft 1 before interior components I (FIG. 2) are installed therein, after the fuselage 2 is connected to the tail assembly 3, 4, wings 5, and engine(s) 6, but without any cargo, passengers or personnel within the aircraft 1. In a particular embodiment, the assembled aircraft corresponds to the aircraft in the assembly or production line, right before the interior components are installed therein. The term “interior component” as used herein is intended to include, without being limited to, interior wall and overhead panels, dividers, furniture (seats, tables, divans, beds, etc.), bins, cabinets, carpets, sanitary equipment (toilet, sink, shower, etc.), kitchen equipment (ovens, microwaves, sinks, coffee and/or tea makers, etc.), electronic equipment (TV, DVD player, music system, phone/computer interface, etc.).

Still referring to FIG. 3, in a particular embodiment, the fuselage portion 12 includes a structure identical to that of part or a whole of the fuselage 2, with stiffened skins 24 interconnected to form a tubular wall, a floor structure 26 extending within the fuselage portion 12 and connected to the stiffened skins 24 on its opposed longitudinal sides and through suitable supports extending downwardly from the floor structure 26, window openings 28 and door openings 30 defined though the stiffened skins 24, etc. In a particular embodiment, the fuselage portion 12 of the test rig 10 is representative of a mid-fuse section and of a transition section (e.g., front fuselage section having a progressively reducing diameter for mating with a cockpit) of the fuselage 2 of the aircraft 1; other configurations are also possible.

In a particular embodiment, one or more “real” fuselage section(s) (i.e., identical to that used in the assembled aircraft) is/are used to create the fuselage portion 12 of the test rig 10. The fuselage portion 12 is accordingly formed from one or more assembly-grade fuselage component(s) each identical to a corresponding component of the fuselage of the assembled aircraft. However, as detailed below, the test rig 10 also includes additional structural elements not present in the assembled aircraft 1, which interact with the assembly-grade fuselage component(s). Other configurations are also possible.

The fuselage portion 12 of the test rig 10 has an initial configuration, before any deformation is applied, which in a particular embodiment corresponds to the configuration of the fuselage 2 before assembly with the rest of the aircraft components, e.g., the “straight” fuselage 2. The fuselage portion 12 is deformable to a deformed configuration corresponding to that of the fuselage 2 within the assembled aircraft.

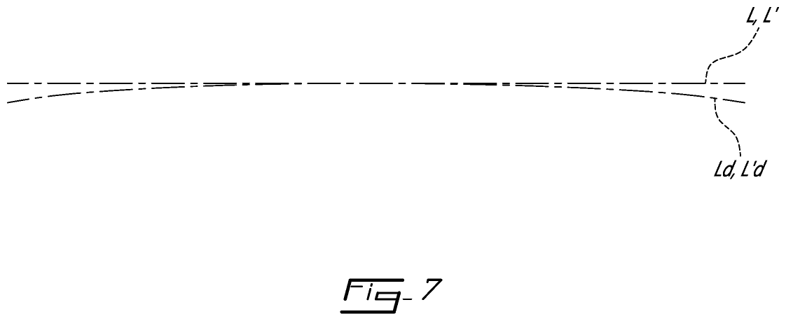

As illustrated by FIG. 7, when the assembled aircraft is static on the ground and supported by its landing gear, the fuselage 2 is bent along its longitudinal axis L, due to the weight of the various aircraft components (interior and exterior, e.g. tail assembly 3, 4, wings 5, engine(s) 6, see FIG. 1) attached to the fuselage 2, so that the longitudinal axis L is bent downwardly at the front and rear ends of the fuselage 2 to a bent configuration Ld. Similarly, the fuselage portion 12 of the test rig 10, when in the deformed configuration, is bent along its longitudinal axis L′ until the longitudinal axis L′ has a corresponding bent configuration L′d, so as to simulate the fuselage bending (deflection) that occurs in the fuselage 2 when the assembled aircraft is static on the ground.

However, in the assembled aircraft, the fuselage 2 acts as a spring, further deforming as the amount of weight it supports changes, for example when components are added/changed or when workers enter the assembled aircraft. By contrast, the fuselage portion 12 of the test rig 10 is configured so as to rigidly maintain the deformed configuration, regardless of any additional weight supported by the test rig 10. Accordingly, the fuselage portion 12 of the test rig 10 remains in the deformed configuration when workers enter the fuselage portion 12 and when interior components are installed therein.

As can be best seen in FIG. 3, the fuselage portion 12 of the test rig 10 is maintained in the deformed configuration by the supports 14, 16, 18, 20. In the embodiment shown, the supports include a front support 14, two small intermediate supports 16, a large intermediate support 18, and a rear support 20. All the supports 14, 16, 18, 20 are anchored in the ground surface 22. Each support 14, 16, 18, 20 has a respective height H1, H2, H3, H4, H5 defined between the ground surface 22 and the fuselage portion 12, and the height of at least one of the supports 14, 16, 18, 20 is adjustable so as to bend the fuselage portion 12 along its longitudinal axis L′ to obtain and maintain the deformed configuration. In the embodiment shown, and as detailed further below, all but one of the supports 14, 16, 18, 20 have an adjustable height H1, H2, H3, H5.

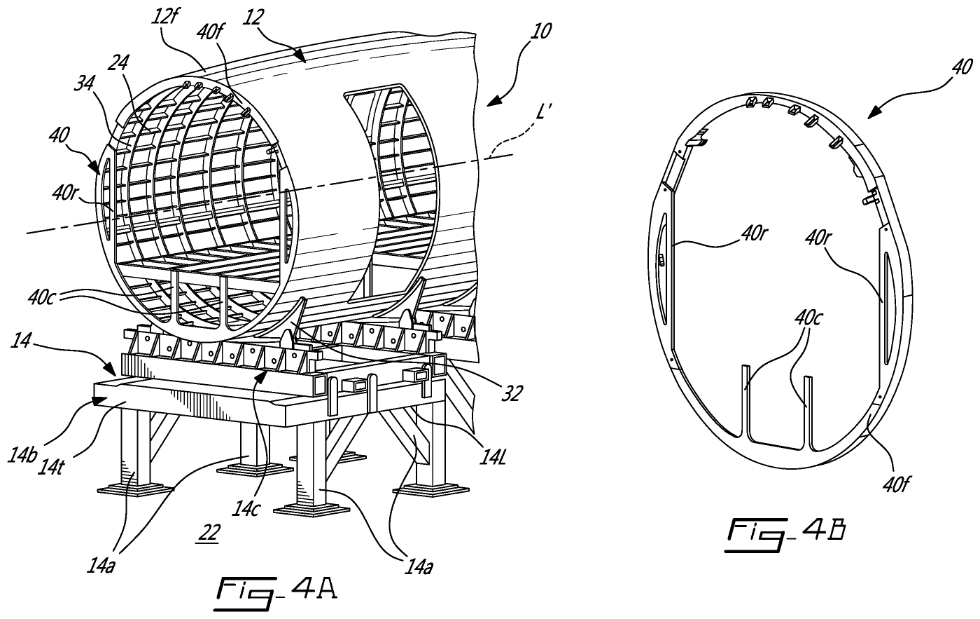

Referring to FIG. 4a, the front support 14 includes a base 14b having four legs 14a, i.e. two pairs of longitudinally spaced apart legs 14a with the two pairs being spaced apart and symmetrically positioned with respect to the longitudinal axis L′. Each leg 14a is anchored to the ground surface 22. The legs 14a are interconnected by a frame defined by two spaced apart longitudinal beams 14L interconnected by two spaced apart transverse beams 14t. The front support 14 further includes a connection portion 14c connected to the base 14b by any suitable adjustment assembly allowing the vertical distance between the connection portion 14c and the base 14b to be adjusted and to be locked at a desired value so that the adjusted support 14 maintains the desired height H1 in a rigid manner.

The connection portion 14c of the front support 14 includes braces 32 structurally connected to the front end 12f of the fuselage portion 12, for example to an annular stiffener 34 extending from an interior surface of the skin 24 of the fuselage portion 12, through any suitable type of connector, for example screws. The connection portion 14c is suitably connected to the fuselage portion 12 so as to be able to “pull” down on the fuselage portion 12 to bend the front end 14f of the fuselage portion 12 downwardly until the deformed configuration is reached.

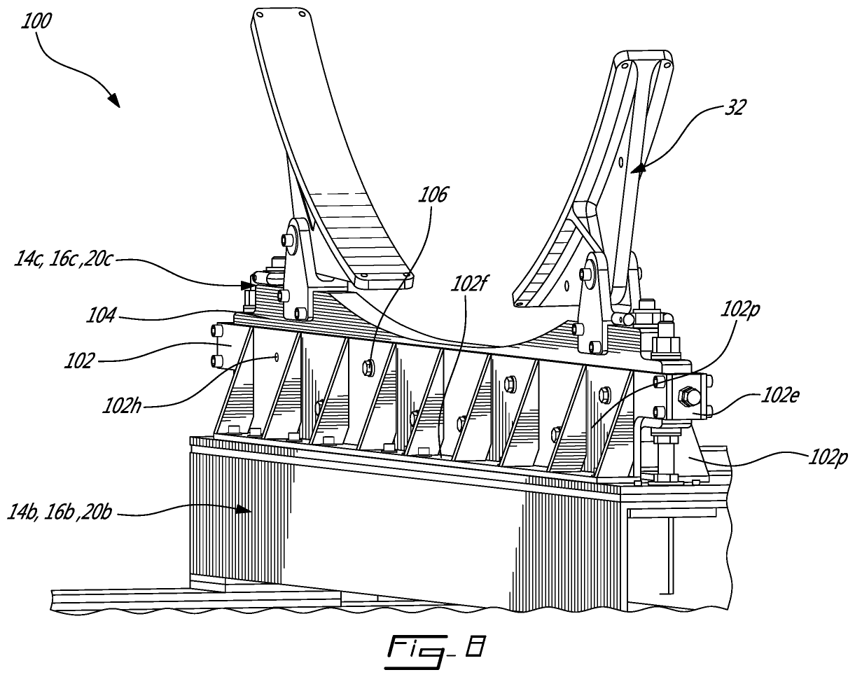

An example of an adjustment assembly 100 which may be used to adjustably connect the connection portion 14c to the base 14b is shown in FIGS. 8-10. Referring to FIG. 8, the adjustment assembly 100 generally includes a fixed element 102 rigidly connected to the base 14b, and the connection portion 14c includes a connection member 104 movably connected to the fixed element 102, as will be further detailed below. It is understood that the term “rigidly connected” is intended to encompass separately formed elements which are interconnected so as to prevent relative movement therebetween, whether the connection is permanent (e.g., welding, brazing) or removable (e.g. with fasteners), as well as elements which are formed as a part of a unitary and/or monocoque component. In the embodiment shown, the fixed element 102 has a flange 102f connected to the base 14b through suitable fasteners; other configurations are also possible.

Still referring to FIG. 8, the fixed element 102 includes two spaced apart vertical plates 102p which are interconnected at their ends 102e, and the connection member 104 is planar and received between the two spaced apart plates 102p and between the ends 102e of the fixed element 102, so as to be surrounded by the fixed element 102. The plates 102p of the fixed elements 102 include longitudinally extending aligned holes 102h defined therethrough, each sized to snuggly receive a fastener 106 (e.g., screw) therethrough.

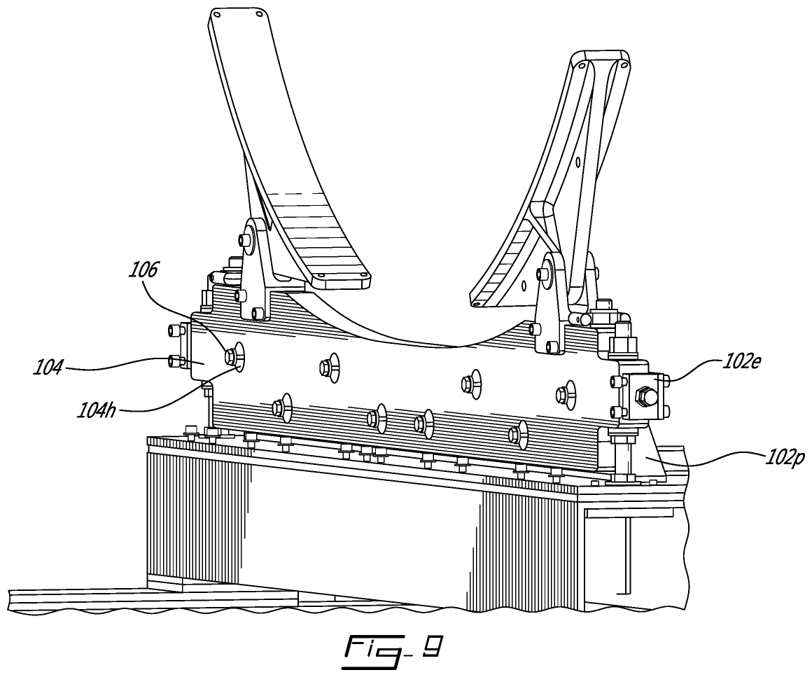

Referring to FIG. 9 where one of the plates 102p is omitted for improved clarity, the connection member 104 also has longitudinally extending holes 104h defined therethrough, in alignment with the holes 102h of the plates 102p. However, the holes 104h of the connection member 104 are larger than the holes 102h of the plates 102p and also larger than the fasteners 106, so that the fasteners 106 snuggly received within the holes 102h of the plates 102p can move within the holes 104h of the connection member 104. The difference between the inner diameter of the holes 104h of the connection member 104 and the outer diameter of the corresponding fastener 106 determines the relative movement that can be obtained between the fixed element 102 and the connection member 104. In the embodiment shown, the holes 104h of the connection member 104 are circular, so that both lateral and vertical adjustment between the connection portion 14c and the base 14b are possible. Other suitable shapes may alternately be used, depending on the desired type of adjustment.

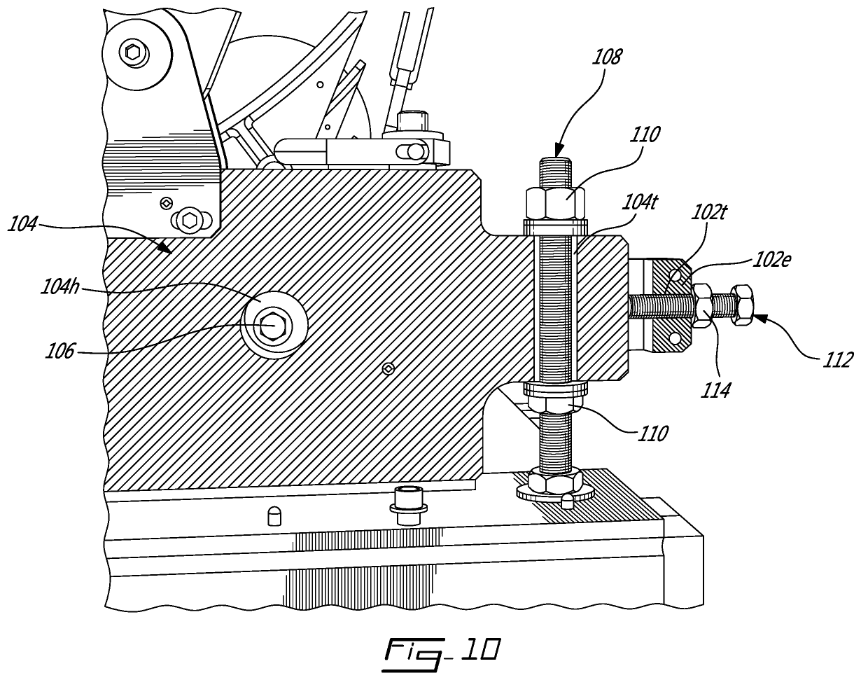

Referring to FIG. 10, the adjustment assembly 100 further includes two spaced apart vertical threaded rods 108 (only one visible in FIG. 10) rigidly connected to the base 14b, one on each end of the connection member 104. Each threaded rod 108 is loosely received through a respective vertical hole 104t defined through the connection member 104, with the hole 104t being sufficiently larger than the threaded rod 108 to allow the desired lateral range of motion of the connection member 104 with respect to the fixed element 102 (as detailed further below), as well as to allow free vertical motion. A nut and lock nut arrangement 110 is engaged to the threaded rod 108 so as to sandwich the connection member 104 and retain it at a desired position along a length of the threaded rod 108; spherical washers may be provided. The vertical distance between the connection portion 14c and the base 14b is adjusted through rotation of the nut and lock nut arrangement 110, which causes the nut and lock nut arrangement 110 to move vertically along the threaded rod 108 and accordingly the connection member 104 to move vertically.

Still referring to FIG. 10, each end 102e of the fixed element has a transverse threaded hole 102t defined therethrough, receiving a lateral horizontal adjustment screw 112 therethrough. The adjustment screw 112 extends through the end 102e of the fixed element 102 and contacts the connection member 104 so as to be able to push against it. The relative lateral position of the connection portion 14c with respect to the base 14b is adjusted through rotation of the adjustment screws 112, which each push the connection member 104 laterally away from the respective end 102e along respective, opposite directions. A lock nut 114 is threaded to the adjustment screw 112 and engages the end 102e of the fixed element 102 to prevent further lateral movement once the desired lateral position is obtained.

Once the desired vertical is obtained via adjustment of the nut and lock nut arrangement 110 along the threaded rods 108, and the desired lateral adjustment is obtained via the adjustment screws 112, the fasteners 106 received through the aligned holes 102h, 104h of the fixed element 102 and of the connection member 104 are tightened so as to lock the relative position of the fixed element 102 and of the connection member 104, and accordingly lock the relative position of the connection portion 14c with respect to the base 14b, and maintain it in a rigid manner.

It is understood that any other suitable adjustment assembly may alternately be used, including, but not limited to, one or more worm screw(s), any suitable ratchet-type arrangement, any suitable hydro-mechanical or hydro-electrical system, etc.

Referring back to FIG. 3, the two similar small intermediate supports 16 are provided rearwardly of the front support 14 and longitudinally spaced apart from each other. Each small intermediate support 16 includes a base 16b having two legs 16a spaced apart and symmetrically positioned with respect to the longitudinal axis L′. Each leg 16a is anchored to the ground surface 22. The legs 16a are interconnected by a transverse beam 16t. Each small intermediate support further includes a connection portion 16c connected to the base 16b by any suitable adjustment assembly allowing at least the vertical distance (and, in a particular embodiment, also the relative lateral position) between the connection portion 16c and the base 16b to be adjusted and to be locked at a desired value so that the adjusted supports 16 maintain the desired height H2, H3 in a rigid manner. In a particular embodiment, the connection portion 16c and the base 16b are connected by an adjustment assembly identical or similar to the assembly 100 described above. It is understood that any other suitable adjustment assembly may alternately be used, including, but not limited to, the other types of adjustment assemblies mentioned above.

The connection portion 16c of each small intermediate support 16 includes braces 32 structurally connected to the fuselage portion 12, for example to another annular stiffener 34 extending from the interior surface of the skin 24 of the fuselage portion 12, through any suitable type of connector, for example screws. The connection portion 16c is suitably connected to the fuselage portion 12 so as to be able to “pull” down on the fuselage portion 12 to bend the fuselage portion 12 downwardly until the deformed configuration is reached.

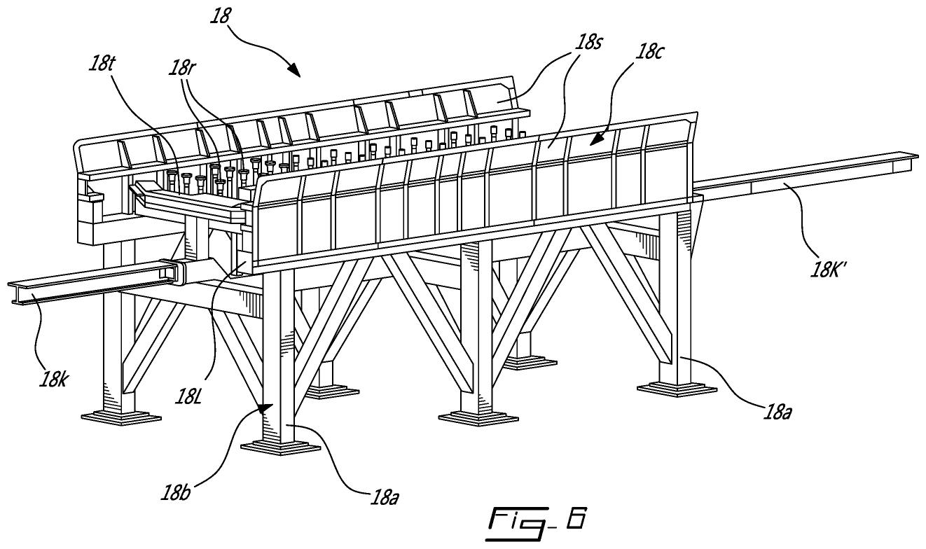

The large intermediate support 18 is provided rearwardly of the small intermediate supports 16. Referring to FIG. 6, the large intermediate support 18 includes a base 18b having six legs 18a, i.e. two groups of three longitudinally spaced apart legs 18a with the two groups being spaced apart and symmetrically positioned with respect to the longitudinal axis L′. Each leg 18a is anchored to the ground surface 22. The legs 18a of each group are interconnected by two spaced apart longitudinal beams 18L, which are interconnected by a plurality of spaced apart transverse beams 18t. The large intermediate support 18 also includes a connection portion 18c connected to the base 18b, and connected to the fuselage portion 12 in a manner representative of a connection between the fuselage 2 of the assembled aircraft and the wings 5 of the assembled aircraft. Since the landing gear of the assembled aircraft is located under the wings 5, the large intermediate support 18 acts as the reference point for the deformed configuration, and does not need to move. Accordingly, the connection portion 18c is connected to the base 18b at a fixed distance with respect thereto, and the large intermediate support 18 has a fixed height H4 (FIG. 3). Other configurations are also possible.

In the embodiment shown in FIG. 6, the connection portion 18c of the large intermediate support 18 includes two spaced apart longitudinal side plates 18s each connected to one of the longitudinal beams 18L. The side plates 18s represent the pressure walls between the fuselage 2 and wings 5 in the assembled aircraft. The side plates 18s are accordingly attached to the fuselage portion 12 in a manner representative of the attachment between the fuselage 2 and the pressure walls in the assembled aircraft, for example by screws, buts, rivets and/or blind rivets.

In the embodiment shown, the connection portion 18c of the large intermediate support 18 also includes a row of attachment rods 18r extending upwardly from each of the transverse beams 18t. Each row includes one attachment rod 18r per seat rail within the fuselage portion 12, and extends through the stiffened skins 24 to be attached to the corresponding seat rail by suitable fastener(s), so as to represent the attachment between the seat rails and the wings 5 in the assembled aircraft.

In the embodiment shown, the connection portion 18c of the large intermediate support 18 also includes a front beam 18k extending forwardly from the base 18b, and a rear beam 18k′ extending rearwardly from the base 18b. The front and rear beams 18k, 18k′ are coaxial and extend longitudinally, aligned with the longitudinal axis L′ of the fuselage portion 12. As can be best seen in FIG. 3, the front and rear beams 18k, 18k′ are connected to the stiffened skins 24 of the fuselage portion 12 in a manner representative of a connection between the fuselage 2 and a keel beam in the assembled aircraft.

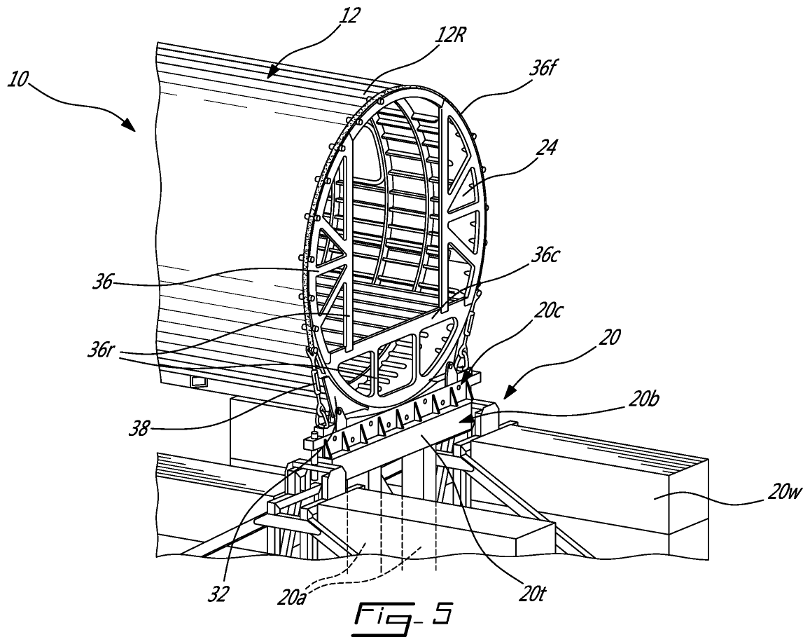

Referring to FIG. 5, the rear support 20 includes a base 20b having two legs 20a spaced apart and symmetrically positioned with respect to the longitudinal axis L′. Each leg 20a is anchored to the ground surface 22. The legs 20a are interconnected by a transverse beam 20t. The rear support 20 further includes a connection portion 20c connected to the base 20b by any suitable adjustment assembly allowing at least the vertical distance (and, in a particular embodiment, also the relative lateral position) between the connection portion 20c and the base 20b to be adjusted and to be locked at a desired value so that the adjusted support 20 maintains the desired height H5 (FIG. 3) in a rigid manner. In a particular embodiment, the connection portion 20c and the base 20b are connected by an adjustment assembly identical or similar to the assembly 100 described above. It is understood that any other suitable adjustment assembly may alternately be used, including, but not limited to, the other types of adjustment assemblies mentioned above.

The connection portion 20c of the rear support 20 includes braces 32 structurally connected to the rear end 12r of the fuselage portion 12. In the embodiment shown, the test rig 10 includes an annular rear bulkhead 36 connected to the rear end 12r of the fuselage portion 12. The rear bulkhead 36 has an annular frame 36f having a shape corresponding to that of a perimeter of the stiffened skin 24 of the fuselage portion 12 and connected to the stiffened skin 24 using any suitable type of fastener (e.g., screws). The rear bulkhead 36 also has a transverse connection member 36c extending across the frame 36f in alignment with and connected to the floor structure 26 using any suitable type of fastener (e.g., screws). The rear bulkhead 36 further includes suitable reinforcement members 36r extending between the frame 36f and the connection member 36c and/or across the frame 36f. Other configurations are also possible.

The connection portion 20c of the rear support 20 is connected to the rear bulkhead 36 through a direct connection between the braces 32 and the bulkhead 36, and also by a cable 38 extending around the bulkhead 36 and having opposed ends attached to the connection portion 20c, so as to be able to “pull” down on the fuselage portion 12 to bend the rear end 12r of the fuselage portion 12 downwardly until the deformed configuration is reached.

In the embodiment shown and as can be best seen in FIG. 3, the rear support 20 further includes two platforms 20p suspended from the transverse beam 12t, with each platform 20p supporting a plurality of stabilization weights 20w. The platforms 20p may be in contact with the ground surface 22, or be located at a fixed distance with respect thereto. The stabilizing weights 20w help reduce the stress on the anchor points connecting the supports 14, 16, 18, 20 to the ground surface 22, so as to avoid the supports 14, 16, 18, 20 “breaking away” from the ground surface 22 when the height of the supports 14, 16, 20 is reduced to “pull down” on the fuselage portion 12. In another embodiment where the ground surface 22 is sufficiently reinforced for example with a suitable foundation, the weights 20w may be omitted.

As can be best seen in FIGS. 4a-4b, in the embodiment shown another annular bulkhead 40 is connected to the front end 12f of the fuselage portion 12. The front bulkhead 40 has an annular frame 40f having a shape corresponding to that of a perimeter of the stiffened skin 24 of the fuselage portion 12 and connected to the stiffened skin 24 using any suitable type of fastener (e.g., screws), and two connection members 40c extending upwardly from a bottom portion of the frame 40f and connected to the floor structure 26 using any suitable type of fastener (e.g., screws). The rear bulkhead 36 also includes suitable reinforcement members 40r extending across the frame 40f. Other configurations are also possible. The front bulkhead 40 provides reinforcement at the front end 12f of the fuselage portion 12 so as to distribute the stress around the perimeter and maintain the cross-sectional shape of the fuselage portion 12, e.g. so as to prevent the deformations applied to the fuselage portion 12 from affecting the cross-sectional shape of the fuselage portion 12; the rear bulkhead 36 performs a similar function on the rear end 12r. In the embodiment shown, the front bulkhead 40 is not attached to the front support 14, and is forwardly offset with respect to the attachment between the front support 14 and the fuselage portion 12. In an alternate embodiment, the front support 14 may be connected to the fuselage portion 12 by being connected to the front bulkhead 40.

The fuselage portion 12 also includes suitable mechanical and system interfaces so as to be able to reproduce the conditions of the installation of the interior components within the assembled aircraft. In a particular embodiment, the systems interfaces are non-functional, i.e. designed to test accessibility of the interfaces as the interior components are installed, but not the functions of the systems; other configurations are also possible. Examples of interfaces include, but are not limited to, interfaces of hydraulic systems and/or of oxygen distribution systems, low and high pressure ducting, harnesses, attachment points and locations on the aircraft stringers and/or frames, attachment locations on floor rails or floor boards, etc.

Referring back to FIG. 2, the test rig 10 also includes suitable elements to facilitate access and use. For example, in the embodiment shown, the test rig 10 includes front and rear platforms 42 to allow access to the interior of the fuselage portion 12 for installation of the interior components I, with each platform 42 being accessible through a respective staircase 44 and including suitable railing 46. The floor structure 26 of the fuselage portion 12 is reinforced so as to provide a reference for measurements, and suitable access for measuring equipment is provided as required. Other configurations are also possible.

In a particular embodiment, the test rig 10 allows for adjustment of an interior component I prior to the component I being installed within the assembled aircraft. Accordingly, at least some of the adjustments to the fit of the interior component I in relation to the assembled aircraft structure, as well as in relation to other interior components I to be received in the assembled aircraft, can be made in parallel of the manufacture of the assembled aircraft. As such, the task of adjusting and configuring interior components I can be done predominantly outside of the production and assembly environment.

In a particular embodiment, a final fit is still required when the interior components I are installed in the assembled aircraft, for example due to variations between the assembled aircraft of a same model caused by the various manufacturing steps. However, the pre-fit of the interior components can be done in the test rig 10 before being installed in an assembled aircraft, so that the pre-fit is already done when the assembled aircraft is ready for the installation of the interior components. In contrast to the prior method of performing the pre-fit within the actual assembled aircraft, the test rig 10 allows for reduced installation time on the assembled aircraft, which allows reducing the overall manufacturing time for the aircraft 1.

In a particular embodiment, the test rig 10 accordingly provides a reduction of fit, form or function problems of the interior components upon installation with the assembled aircraft.

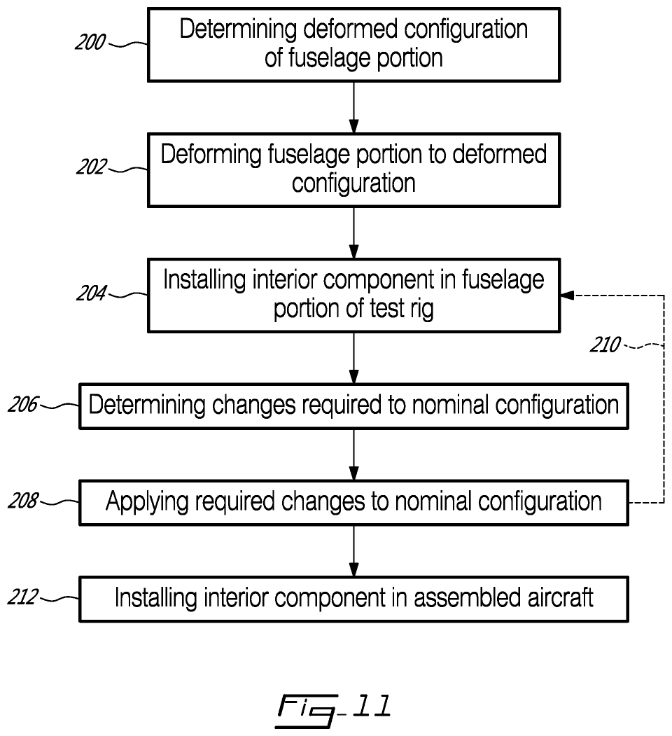

Referring to FIG. 11, in use and in a particular embodiment, the interior component is adjusted in accordance with the following. First, the deformed configuration of the fuselage portion 12 of the test rig 10 is determined using any suitable method, as illustrated in step 200. For example, the deformed configuration can be calculated based on known deformations on the fuselage of the assembled aircraft. In a particular embodiment, the deformations are measured on fuselages of two or more assembled aircraft of the same model, and the deformed configuration is determined based on average values of the corresponding measured deformations in the different aircraft. For example, deformations along the seat rails of the assembled aircraft can be measured to characterize the deformation of the fuselage 2. Any other suitable measuring points allowing to characterize the bending of the fuselage (e.g. “out of plane” bending) can also/alternately be used.

The fuselage portion 12 is then deformed to the deformed configuration, as illustrated in step 202, so that the fuselage portion 12 maintains the deformed configuration in a rigid manner; as mentioned above, the deformed configuration is maintained even if additional weight is supported by the fuselage portion 12 after the deformed configuration is set. In a particular embodiment, the fuselage portion 12 of the test rig 10 is deformed by applying a downward force (“pulling”) on an end of the fuselage portion 12 through an annular bulkhead attached to the end of the fuselage portion 12. In the embodiment shown, the fuselage portion 12 of the test rig 10 is deformed by adjusting a height of one or more of the supports 14, 16, 20. Deformations at one or more points on the fuselage portion 12 can be measured, and the height of the support(s) 14, 16, 20 adjusted until the measured deformations reach desired values corresponding to the deformed configuration. It is however understood that any other suitable method of obtaining the deformed configuration may alternately be used.

The interior component is then installed within the fuselage portion 12 in the deformed configuration, as illustrated in step 204. The changes required to the nominal configuration of the interior component are determined based on the fit of the interior component within the fuselage portion 12 in the deformed configuration, as illustrated in step 206. The required changes are applied to the nominal configuration, as illustrated in step 208, for example by changing the CAD model of the interior component and producing a new component from the updated CAD model, or by machining or otherwise directly changing one or more dimension(s) of the interior component. The installation within the fuselage portion 12 and subsequent changes to the nominal configuration can optionally be repeated as required, until a desired fit is obtained, as illustrated in 210. Once the nominal configuration of the interior component is adjusted for installation in the fuselage portion 12 of the test rig 10 in the deformed configuration with an acceptable fit (e.g., acceptable gaps between interior component and structure and/or between adjacent interior components), the interior component is ready for installation in the fuselage 2 of the assembled aircraft, as illustrated by step 212. The interior component as adjusted can accordingly be reproduced based on the adjusted nominal configuration for installation within the assembled aircraft of the same model.

In a particular embodiment, an installation procedure is established before installing the interior component within the fuselage portion 12 of the test rig 10, and the interior component is installed within the fuselage portion 12 in the deformed configuration following that procedure. Changes required to the installation procedure are then determined based on the installation within the fuselage portion 12, and the changes are applied to the installation procedure before using it to install the interior component within the assembled aircraft.

In a particular embodiment, a second interior component is installed adjacent the first interior component within the fuselage portion 12 of the test rig 10 in the deformed configuration. The changes required to the nominal configuration of the second interior component are then determined based on a fit of the second interior component within the fuselage portion 12 in the deformed configuration and on a fit of the second interior component with the first interior component. The required changes are applied to the nominal configuration of the second interior component before installing the second interior component in the fuselage 2 of the assembled aircraft.

In a particular embodiment, the test rig 10 is tailored to a particular aircraft model, and can be used to test all the different interior configurations applied to the aircraft model, in various configurations of the aircraft (e.g. different components producing different deformations on the fuselage). New complete interior configurations, new zones in existing interior configurations, and changes to one or more zones or to the whole of existing interior configurations can be tested and fitted before the interior components are installed in the assembled aircraft. In a particular embodiment, the test rig 10 allows testing of the fit, form and function of the interior components, and accordingly to determine and fix installation problems before installing the interior components within the assembled aircraft, which can reduce cycle time by reducing disruptions of the assembly line. In a particular embodiment, the test rig 10 can also be used as a training tool for the installation of interior components, particularly, although not exclusively, for a new aircraft program.

In a particular embodiment, the test rig 10 is also used for testing of installation procedures, so as to increase efficiency for the installation of the interior components within the assembled aircraft. For example, the parallel task capability of the installation procedures and the buffer zones (e.g. zones where the interior panels can bend, thus eliminating the need to trim to obtain an acceptable fit) can be tested. The quality of the installation can also be tested with respect to the range of tolerances accepted on the dimensions of the interior components.

Although the test rig 10 has been described with respect to an aircraft, it is understood that a similar test rig 10 can be provided for any vehicle having a fuselage or other type of cabin having a deformed configuration in the assembled vehicle, and in which interior components need to be installed.

While the methods and systems described herein have been described and shown with reference to particular steps performed in a particular order, it will be understood that these steps may be combined, sub-divided or reordered to form an equivalent method without departing from the teachings of the present invention. Accordingly, the order and grouping of the steps is not a limitation of the present invention.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A method of adjusting an interior component to be received in a fuselage of an assembled aircraft, the fuselage of the assembled aircraft being bent along a longitudinal axis thereof due to a weight of aircraft components attached to the fuselage, the method comprising:
determining a deformed configuration of a fuselage portion of a test rig, the fuselage portion in the deformed configuration being bent along a longitudinal axis thereof, the fuselage portion in the deformed configuration being representative of at least part of the fuselage of the assembled aircraft;
deforming the fuselage portion of the test rig to the deformed configuration so that the fuselage portion maintains the deformed configuration in a rigid manner;
installing the interior component within the fuselage portion of the test rig in the deformed configuration;
determining changes required in a nominal configuration of the interior component based on a fit of the interior component within the fuselage portion in the deformed configuration; and
applying the required changes to the nominal configuration of the interior component before installing the interior component within the fuselage of the assembled aircraft.

2. The method as defined in claim 1, wherein the assembled aircraft is a first assembled aircraft forming part of a plurality of assembled aircraft of a same aircraft model, the method further comprising, before deforming the fuselage portion of the test rig:
measuring deformations of fuselages of the plurality of assembled aircraft; and
determining the deformed configuration of the fuselage portion of the test rig based on average values of the measured deformations.

3. The method as defined in claim 1, wherein deforming the fuselage portion of the test rig includes applying a downward force on an end of the fuselage portion of the test rig through an annular bulkhead attached to the end of the fuselage portion.

4. The method as defined in claim 1, wherein the fuselage portion of the test rig is supported above a ground surface by a plurality of supports anchored in the ground surface and connected to the fuselage portion, each of the supports having a height defined between the ground surface and the fuselage portion, and deforming the fuselage portion includes adjusting the height of at least one of the supports.

5. The method as defined in claim 4, wherein an intermediate one of the supports is connected to the fuselage portion in a manner representative of a connection between the fuselage of the assembled aircraft and wings of the assembled aircraft, the intermediate one of the supports having a fixed height, and adjusting the height of at least one of the supports includes adjusting the height of a front one of the supports and adjusting the height of a rear one of the supports, the intermediate one of the supports being located between the front and rear ones of the supports.

6. The method as defined in claim 1, wherein installing the interior component within the fuselage portion of the test rig in the deformed configuration is performed in accordance with an installation procedure, the method further comprising:
determining changes required in the installation procedure; and
applying the required changes to the installation procedure before using the installation procedure to install the interior component within the fuselage of the assembled aircraft.

7. The method as defined in claim 1, wherein the interior component is a first interior component, the method further comprising:
installing a second interior component adjacent the first interior component within the fuselage portion of the test rig in the deformed configuration;
determining changes required in a nominal configuration of the second interior component based on a fit of the second interior component within the fuselage portion of the test rig in the deformed configuration and on a fit of the second interior component with the first interior component; and
applying the required changes to the nominal configuration of the second interior component before installing the second interior component in the fuselage of the assembled aircraft.

8. The method as defined in claim 1, wherein the aircraft components attached to the fuselage include a tail assembly and at least one engine.

9. A method of installing an interior component in a fuselage of an assembled aircraft, the fuselage being bent along a longitudinal axis thereof due to a weight of aircraft components attached to the fuselage, the method comprising:
deforming a fuselage portion of the test rig to a deformed configuration so that the fuselage portion maintains the deformed configuration in a rigid manner, the fuselage portion in the deformed configuration being bent along a longitudinal axis thereof, the fuselage portion in the deformed configuration being representative of at least part of the fuselage of the assembled aircraft;
installing the interior component within the fuselage portion of the test rig in the deformed configuration;
determining changes required in a nominal configuration of the interior component based on a fit of the interior component within the fuselage portion of the test rig in the deformed configuration;
removing the interior component from the fuselage portion of the test rig and applying the required changes to the nominal configuration of the interior component; and
after the required changes are applied, installing the interior component within the fuselage of the assembled aircraft.

10. The method as defined in claim 9, wherein the assembled aircraft is a first assembled aircraft forming part of a plurality of assembled aircraft of a same aircraft model, the method further comprising:
measuring deformations of fuselages of the plurality of assembled aircraft; and
determining the deformed configuration of the fuselage portion of the test rig based on average values of the measured deformations.

11. The method as defined in claim 9, wherein deforming the fuselage portion of the test rig includes applying a downward force on an end of the fuselage portion of the test rig through an annular bulkhead attached to the end of the fuselage portion.

12. The method as defined in claim 9, wherein the fuselage portion of the test rig is supported above a ground surface by a plurality of supports anchored in the ground surface and connected to the fuselage portion, each of the supports having a height defined between the ground surface and the fuselage portion, and deforming the fuselage portion includes adjusting the height of at least one of the supports.

13. The method as defined in claim 12, wherein an intermediate one of the supports is connected to the fuselage portion in a manner representative of a connection between the fuselage of the assembled aircraft and wings of the assembled aircraft, the intermediate one of the supports having a fixed height, and adjusting the height of at least one of the supports includes adjusting the height of a front one of the supports and adjusting the height of a rear one of the supports, the intermediate one of the supports being located between the front and rear ones of the supports.

14. The method as defined in claim 9, wherein installing the interior component within the fuselage portion of the test rig in the deformed configuration is performed in accordance with an installation procedure, the method further comprising:
determining changes required in the installation procedure; and
applying the required changes to the installation procedure before using the installation procedure to install the interior component within the fuselage of the assembled aircraft.

15. The method as defined in claim 9, wherein the interior component is a first interior component, the method further comprising:
installing a second interior component adjacent the first interior component within the fuselage portion of the test rig in the deformed configuration;
determining changes required in a nominal configuration of the second interior component based on a fit of the second interior component within the fuselage portion of the test rig in the deformed configuration and on a fit of the second interior component with the first interior component;
applying the required changes to the nominal configuration of the second interior component; and
after the required changes are applied to the nominal configuration of the second interior component, installing the second interior component within the fuselage of the assembled aircraft adjacent the first interior component.

16. The method as defined in claim 9, wherein the aircraft components attached to the fuselage include a tail assembly and at least one engine.

17. A test rig for adjusting interior components to be received within a fuselage of an assembled aircraft, the rig comprising:
a fuselage portion having a longitudinal axis, the fuselage portion having a structure representative of that of at least part of the fuselage of the assembled aircraft; and
a plurality of longitudinally spaced supports anchored in a ground surface and supporting the fuselage portion in an elevated position with respect to the ground surface, each of the supports having a height defined between the ground surface and the fuselage portion, the height of at least one of the supports being adjustable so as to bend the fuselage portion along the longitudinal axis to obtain and maintain a deformed configuration representative of deformations in the at least part of the fuselage of the assembled aircraft.

18. The test rig as defined in claim 17, wherein the supports include an intermediate support located between front and rear supports, the intermediate support connected to the fuselage portion in a manner representative of a connection between the fuselage of the assembled aircraft and wings of the assembled aircraft, the height of the intermediate support being fixed, the height of the front and rear supports being adjustable.

19. The test rig as defined in claim 18, wherein the intermediate support includes a front beam extending forwardly therefrom and a rear beam extending forwardly therefrom, the front and rear beams connected to the fuselage portion in a manner representative of a connection between the fuselage of the assembled aircraft and a keel beam of the assembled aircraft.

20. The test rig as defined in claim 18, wherein the front and rear supports are connected to annular stiffeners extending from an interior surface of a skin of the fuselage portion.

21. The test rig as defined in claim 17, further including an annular bulkhead connected to a rear end of the fuselage portion, a rear one of the supports being connected to the annular bulkhead.

22. The test rig as defined in claim 21, further comprising a cable extending around the bulkhead and having opposed ends attached to the rear one of the supports.

23. The test rig as defined in claim 17, wherein the fuselage portion includes an assembly-grade fuselage component identical to a corresponding component of the fuselage of the assembled aircraft.
